(19) United States
(12) Patent Application Publication
(10) Pub. No.: US 2004/0111717 A1
(43) Pub. Date: Jun. 10, 2004

(54) Software modification

(76) Inventor: Melih Abdulhayoglu, Worsley (GB)

Correspondence Address: ADAM EVANS, P.A., (formerly Adams, Schwartz & Evans, P.A.), 2180 TWO WACHOVIA CENTER, CHARLOTTE, NC, 28282, US

(21) Appl. No.: 10/467,577

(22) PCT Filed: Feb. 8, 2002
(86) PCT No.: PCT/GB02/00552

(30) Foreign Application Priority Data
Feb. 8, 2001 (GB) 0103119.4

(51) Int. Cl. G06F 9/45

(52) U.S. Cl. 717/149; 717/130; 717/106

(57) ABSTRACT

A method of modifying software comprising the steps of: (i) selecting a self-containing instruction set from the software; and (ii) modifying the software whereby when executed the selected self-containing instruction set is executed in a separate processor.

### FIELD OF THE INVENTION

The present invention relates to software modification methods, data carriers carrying such methods and to corresponding processes for executing such modified software.

### BACKGROUND TO THE INVENTION

Piracy of computer software is a growing problem and many efforts have been made to solve it by protecting the executable code. One such approach is by encryption. However there is a fundamental problem with current approaches to this problem in that no matter how well the executable code of the software is protected by encryption, it has to be decrypted so that a processor can execute the instructions. For a software pirate skilled in the art, it is a relatively simple procedure for them to examine the code being executed by the processor no matter what the security being employed to transfer the executable code from a provider to the user.

Accordingly, a software pirate can examine the operation of the processor carrying out the instructions to build a working copy of the executable code hence defeating any protection.

Preferred embodiments of the present invention aim to obviate or overcome a problem of the prior art, whether referred to herein or otherwise.

### SUMMARY OF THE INVENTION

According to the present invention in a first aspect, there is provided a method of modifying software comprising the steps of:

(i) selecting a self-contained instruction set from the software; and

(ii) modifying the software whereby when executed the selected self-contained instruction set is executed in a separate processor.

By making the method reliant on a self-contained instruction set executed elsewhere a potential pirate will at least find it harder and in preferred embodiments be largely prevented from determining the nature of the code. All that the pirate will be able to examine is the inputs and outputs to and from, respectively, the self-contained portion.

Suitably, the separate processor is separate from the processor executing the non-selected, self-contained instruction set.

Suitably, the selected self-contained instruction set is removed from the software. Suitably, the removed selected self-contained instruction set is replaced by an instruction to perform a corresponding instruction set on the separate processor. Suitably, the instruction-set comprises an instruction to enter a debugger mode. Suitably, the removed self-contained instruction set is replaced by a corresponding length of substitute code.

Suitably, the method includes the step of encrypting the selected self-contained instruction set.

Suitably, the encryption is for a specific processor. The specific processor will have a substantially unique decryption key. Suitably, the encryption uses a public key encryption process.

Suitably, the selected self-contained instruction set is encrypted using a substantially unique encryption algorithm. Suitably, the substantially unique encryption algorithm corresponds to the substantially unique encryption algorithm of a processor adapted to decrypt and execute the encrypted self-contained instruction set. Suitably, the algorithm comprises a secret key algorithm. This is an asymmetric algorithm. Optionally, the encrypted selected self-contained instruction set is re-inserted into the software.

Suitably, the processor is independent of a processor executing the non-encrypted software.

Suitably, modification of the software includes providing wrapper software with the software.

Suitably, an instruction set is only selected if it is of a predetermined minimum length.

Suitably, the software is modified to provide the separate processor with at least one register entry for executing the selected self-contained instruction set.

Suitably, the software is modified whereby the selected self-contained instruction set is retrieved from a location other than the source of the software. Typically this will be via the Internet or from another distributed electronic network. Suitably, the retrieval occurs upon installation of the software.

Suitably, the method includes the step of selecting and modifying plurality of self-contained instruction sets.

According to the present invention in a second aspect, there is provided a method of executing software on a computer, the method comprising the steps of:

(i) upon reading an appropriate instruction, executing a self-contained instruction set in a separate processor; and

(ii) providing the result of the executed self-contained instruction set to the software.

Suitably, the software is according to the first aspect of the invention.

Suitably a self-contained instruction set is provided separate from the software. Typically this will be via the internet or from another distributed electronic network.

Suitably, the appropriate instruction is an instruction to carry out an instruction set on a processor separate from a main processor, typically a central processing unit (CPU). Suitably, the appropriate instruction provides at least one register entry to the separate processor.

Suitably, an updated register entry is provided with the result of the executed self-contained instruction set. Suitably, the self-contained instruction set is executed on a secure processor, secure part of a processor or on a processor in a secure node. Suitably, the self-contained instruction set is executed on a processor other than a CPU.

Suitably, the encryption is for a specific processor. The specific processor will have a substantially unique decryption key. Suitably, the encryption uses a public key encryption process.

Suitably, the self-contained instruction set is encrypted. Suitably, the selected self-contained instruction set is encrypted using a substantially unique encryption algorithm. Suitably, the substantially unique encryption algorithm corresponds to the substantially unique encryption algorithm of a processor adapted to decrypt and execute the encrypted self-contained instruction set. Suitably, the algorithm comprises a secret key algorithm. This is a symmetric algorithm. Suitably, the processor is independent of a processor executing the non-encrypted software.

Suitably, the self-contained instruction set is stored on memory of the separate processor. Suitably, the self-contained instruction set is encrypted and is decrypted by the separate processor.

Suitably, the method comprises the step of inserting in the software at the location of the self-contained instruction set a command to execute the encrypted self-contained instruction set. Suitably, the command comprises an instruction to enter a debugger mode.

According to the present invention in a third aspect, there is provided a data carrier comprising software modified according to the first aspect of the invention.

According to the present invention in a fourth aspect, there is provided software modified according to the first aspect of the invention.

According to the present invention in a fifth aspect, there is provided a software execution process, the process comprising;

(i) providing software from which a self-contained instruction set has been modified to enable execution of the selected self-contained instruction set on a separate processor; and

(ii) executing the software during which the self-contained instruction set is executed on a separate processor.

Suitably, a self-contained instruction set is obtained from a separate source and installed on the computer. Typically this will be via the internet.

Suitably, the self-contained instruction set is encrypted.

Suitably, the encryption is for a specific processor. The specific processor will have a substantially unique decryption key. Suitably, the encryption uses a public key encryption process.

Suitably, the selected self-contained instruction set is encrypted using a substantially unique encryption algorithm. Suitably, the substantially unique encryption algorithm corresponds to the substantially unique encryption algorithm of a processor adapted to decrypt and execute the encrypted self-contained instruction set. Suitably, the algorithm comprises a secret key algorithm. This is a symmetric algorithm. Suitably, the processor is independent of a processor executing the non-encrypted software. Suitably, the process includes the step of a separate process for decrypting the encrypted self-contained instruction set. Suitably, the self-contained instruction set is stored on the separate processor.

Suitably, the method comprises the step of inserting in the software at the location of the self-contained instruction set a command to execute the encrypted self-contained instruction set. Suitably, the command comprises an instruction to enter a debugger mode.

Suitably, the encrypted self-contained instruction set is executed on a secure processor, a secure part of a processor or on a processor in a secure mode. Suitably, the encrypted self-contained instruction set is executed on a processor other than the CPU.

Suitably, the software is according to the fourth aspect of the invention.

Each aspect of the present invention may be incorporated with features of other aspects of the present invention, unless the context requires otherwise.

### BRIEF DECRIPTION OF THE DRAWINGS

The present invention will now be described, by way of example only, with reference to the drawings that follow; in which;

FIG. 1 is a schematic block diagram illustrating features of a first embodiment of the present invention.

FIG. 2 is a schematic illustration of software modified according to the present invention.

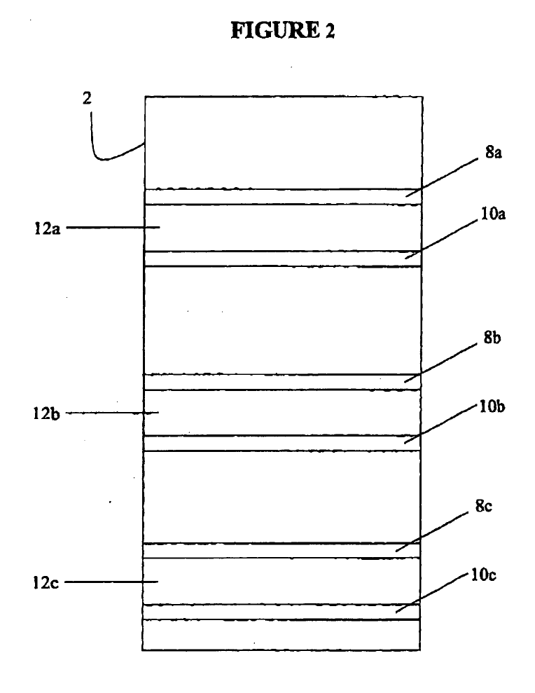

FIG. 3 is a schematic code diagram illustrating code module format of a second embodiment of the present invention.

### DESCRIPTION OF THE PREFERRED EMBODIMENTS

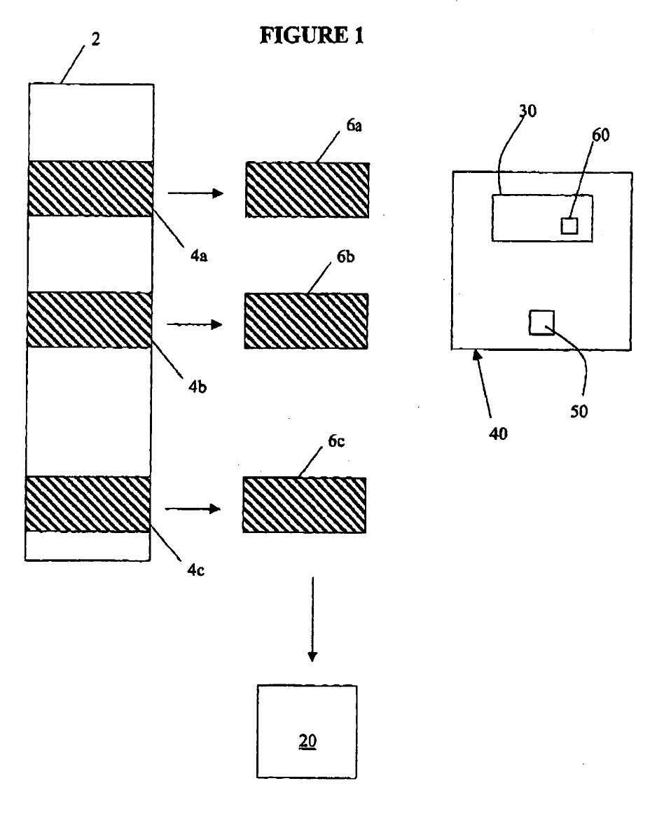

In FIG. 1 there is shown schematically an executable software 2 such as an application (e.g. WORD (trade mark), a game or the like.

In overview, according to this embodiment of the present invention, a selection is made from the software 2 of self-contained instruction sets 4a, 4b and ⁴c, which are removed from the executable program 2 and encrypted as indicated at 6a, 6b and 6c respectively. Each such encrypted instruction set 6a, 6b and 6c is stored separately, in a secure database 20. Header 8a, 8b, 8c and footer 10a, 10b, 10c code is added to the original software 2 and the positions from which the self-contained instruction sets have been removed.

If necessary “wrapper software” is added to the software 2 to configure it to operate in its modified state.

When a pirate attempts to copy the program he or she will only obtain the program with the encrypted portions which will not run without appropriate decryption means.

When run, the modified executable 2 (with the encrypted segment) includes wrapper software which obtains the encrypted self-contained instruction sets 6a, 6b and 6c from the secure database 20. The encrypted self-contained instruction sets 6a, 6c and 6c are decrypted by a separate secure processor 30 and stored therein. When the first header code 8a is reached, the software sends the register entries to the separate secure processor 30 with an identifier of which self-contained instruction set is to be executed. The separate processor 30 executes the decrypted instruction set 4a, executes the relevant instructions and returns the generated output to the executable program 2 with the registers updated. Each removed instruction set is executed accordingly, Thus a potential pirate cannot access the encrypted portions of the executable software because they are only executed in an environment to which the pirate cannot obtain access. By encrypting the self-contained instruction sets 4a, 4b and 4c uniquely for each machine, unauthorised copying can be prevented.

More detail of a preferred embodiment is now described. A computer 40 (such as an IBM compatible personal computer) has a CPU so is provided with a separate secure processor 30 such as a Z80 based processor containing a substantially unique encryption code. A suitable encryption code is a public/secret key based algorithm. The keys typically are 512 bits long and neither the public nor secret key is known publicly (the terms public and secret key are, however, retained as terms of art). By “substantially unique” it is meant that the code may be duplicated, but so infrequently that the probability of two machines with the same combination being discovered is satisfactorily remote.

The processor 30 includes access to dedicated secure random access memory (RAM) 60 and is configured whereby it is capable of encryption, decryption, carrying out a set of instructions and outputting a result thereof.

The processor 30 is secure because its internal operation cannot practically be inspected.

To encrypt the code 2, a self-contained segment is selected therefrom. By “Self-contained” is meant that the selected instruction set can be carried out using input variables, such as from central processor unit register values and/or flags etc, without requiring further input from external of the processor until the end of the relevant instruction set. Thus, self-contained code can operate without any external dependencies within normal memory. This means, to be self-contained, an instruction operates on CPU registers and not memory. It may be regarded as an “atomic” instruction.

A minimum code length for encryption, eg 10 bytes, may be specified. Shorter self-contained code blocks are not encrypted.

To determine self-contained instruction sets the software 2 is disassembled for analysis. This produces an address, an operator and an operand. The operator is inspected to determine whether it is of a type suitable for encryption (eg an arithmetic or Boolean). The operands are then inspected to determine whether they are purely register oriented. Both checks must be satisfied to qualify for conversion. A code fragment to perform this is met out below:

```
BOOL disassemble80x86 (BYTE *data,char *code,DWORD offset,
DWORD *length,DWORD *branch,BOOL *stop,BOOL *convert,
DWORD upLevel, char *Z80,char *consts)
{
    BOOL okay=TRUE;
    DWORD len=0;
    BOOL regExt=FALSE;
    BooladdrExt=FALSE;
    BOOL found=FALSE;
    BOOL failed=FALSE;
    DWORD dis_off=offset;
    char dis_text [256];
    DEBUGPACKET dp;
    memset (&dp, 0, sizeof dp);
    // dont stop (not yet... we may find a bad instruction etc)
    *stop=FALSE;
    // no branch found (yet)
    *branch=−1;
    // no conversion
    *convert=0;
    // disasemmble current instruction
      failed=!disasm(&dp, &dis_off,data,dis_text,stop,branch,convert,T
RUE);
    strcpy(code,itah8(offset));
    strcat(code,“ ”);
    // if no op-code was found - then say so!
    if (failed)
    {
        okay=FALSE;
        len=0;
            // create small memory dump of unknown instruction
        strcat(code,itah2(data[0]));
        strcat(code,itah2(data[1]));
        strcat(code,itah2(data[2]));
        strcat(code,itah2(data[3]));
        strcat(code,itah2(data[4]));
        strcat(code,itah2(data[5]));
        strcat(code,itah2(data[6]));
        strcat(code,itah2(data[7]));
        strcat(code,“ Bad op-code!”);
    }
    else
    {
        strcat(code,dis_text);
        len=dis_off-offset;
    }
    // if we can convert, and we want to convert; then convert!
    if (*convert)
    {
        BOOL done=FALSE;
        char code[64];
        // write code for register addressing and size
        if (Dis80x86_Z80_RegSize(GetSubStr(dis_text,1)))
        {
        // set first register pointer
        sprintf(code,“1dde,%s”,Dis80x86_Z80_RegAddr
        GetSubStr(Dis_te
    xt,1)));
            Z80Append(Z80,code);
        // set second register pointer (if applicable)
            if (Dis80x86_Z80_RegSize(GetSubStr(dis_text,2)))
            {
                sprintf(code,“1d
h1,%s”,Dis80x86_Z80_RegAddr(GetSubStr(dis_text,2)));
              Z80Append(Z80,code);
            }
            else
            {
                // check if we have a constant here
                  if (*GetSubStr(dis_text,2))
                  {
                    // we have a constant - build pointer to it
                      sprintf(code,“1d
h1,%s”,Dis80x86_Z80_ConstAddr(getSubStr(dis_text,2)));
                      Z80Append(Z80,code);
                        // and build the constant
sprintf(code,“.%s”,Dis80x86_Z80_ConstAddr(GetSubStr(dis_text,2)));
                      Z80Append(consts,code);
                          sprintf(code,“dd %s”,Dis80x86_Z80_{—}
                          ConstAddr(GetSubStr(dis_text,2)));
                      Z80Append(consts,code);
                  }
            }
            // set first register size
            sprintf(code,“1d
bc,%d”.Dis80x86_Z80_RegSize(GetSubStr(dis_text,1)));
            Z80Append(Z80,code);
        }
      if (strcmp(GetSubStr(dis_text,0),“adc”)==0)
      {
        Z80Append(Z80,“call macro_adc”);
          done=TRUE;
      }
        if (strcmp(getSubStr(dis_text,0),“add”)==0)
      {
            Z80Append(Z80,“call macro_add”);
          done=TRUE;
      }
      if (strcmp(GetSubStr(dis_text,0),“and”)==0)
      {
        Z80Append(Z80,“call macro_and”);
          done=TRUE;
      }
This works as follows:
    // Ensure user stack is initially empty
    Clear Stack
    // Place entry point of EXE onto the stack
    Push EXE entry point
    // Keep goings until the stack is exhausted
    While (Stack not empty)
    // Set Op Code to a ‘null’ value
    OpCode:=NOP;
    // Get instruction pointer from stack
    IP:=Pop stack
    While (OpCode is not a RET)
    {
        // Get Op Code from location pointed to by IP
        OpCode:=[IP]
        // check if the Op Code is convertible to Z80
        if (OpCode Arithmetic/Immediate/Boolean)
        {
            // save location of OpCode and Size
            Store address of Opcode and Opcode size
        }
        // Check for a CALL op Code
        if (OpCode is a CALL)
        {
            //store call address on to stack
            Push CALL address
        }
        // check for a condition branch
        if (OpCode is a CondBranch)
        {
            //store branch destination on to stack
            Push effective branch address
        }
        // check for a jump instruction
        if (OpCode is a Jmp)
        {
            // change program flow
            IP:=Jump Address
        }
        else
        {
            // if it was not a jump then continue a normal
            IP:=IP = OpCodeLength
        }
    }
}
    // Sort the usable OpCode addresses to that we can scan thru'
    // later
    Sort OpCode addresses
    End
```

The selected segment is removed (deleted) from the software.

The selected segment may not be in the language of the processor 30, and in the case of a Z80 processor in a typical PC (using 8086 code) will not be. Accordingly, as a first step the selected segment is compiled to the Z80 processor language and then encrypted according to the secret key thereof.

The encrypted selected segment is stored in a secure database for later use as described below. The encryption may be carried out separate from the computer 40 by a trusted source having access to the relevant public/secret key pair and symmetric key for separate processor 30.

The transfer of keys (in particular a symmetric key) between the trusted source and secure processor 30 is carried out using public key encryption, while the selected segment is encrypted using faster symmetric encryption, such as DES, based on the symmetric key.

The software from which the selected segment has been removed is modified by the provision of wrapper software and by substitute null commands 12a, 12b and 12c (such as INT0×03) in place of the removed selected segment. The substitute commands instruct the execution of the removed selected segment. One option for doing so is to use the INT0×03 instruction to enter a debugger mode. The selected segment is registered as the debugger of that particular executable. Hence, when the executable comes to the replaced section it relinquishes control of the debugger software which is configured appropriately.

Each user's computer incorporate a substantially unique secure processor 30. The processor 30 has a substantially unique public/secret key pair and, for administrative purposes, an index number. The public/secret key pair is known only to a trusted source. The trusted source includes a secure database on which the encrypted segment is stored, encrypted for each medium.

Upon installation of the software on a user's computer the wrapper software requires the user to download from the secure database the encrypted selected segment which is then stored locally, typically on the hard drive of the user's computer. The download is typically carried out via the internet. The user's computer will identify itself by its index number to the trusted source with access to the secure database, which trusted source provides the encrypted selected segment to the user's computer according to the public/secret key of the user's Z80 processor. The trusted source may encrypt the segment on demand instead of pre-storing the encrypted cipher text.

The substitute header commands when reached in execution of the software provide for the encrypted selected segment to be delivered to the Z80 separate processor 30 together with the main processor registers stored in the on-board RAM of the CPU 50. The separate processor 30 decrypts the encrypted selected segment storing the result in its on-board RAM 60, and executes the decrypted segment. As mentioned above, the segment has been compiled into Z80 language. The result of the executed segment is output to the software and any corresponding registers are altered as required,

The software then continues as normal until another such instruction set is reached.

The remainder of the software is executed on the CPU 50.

Accordingly, this preferred embodiment of the present invention prevents a potential pirate ever from inspecting the selected segment other than in a securely encrypted format, which is of no use to them. The potential pirate cannot inspect the internal operation of the separate, independent Z80 processor, only the input thereto (encrypted selected segment and registers) and outputs therefrom (result of execution of decrypted selected segment). The software is, therefore, secure from piracy. Even if the potential pirate copies the software to another computer, in the case of this preferred embodiment it will not operate as the other computer even if it has an independent Z80 processor, it will be encrypted differently (i.e. a different secret/public key pair).

Typically there will be a plurality of encrypted segments in a software encoded as described above.

Alternatively the selected segments stored in a database need not he encrypted Instead they can be encrypted when required to be sent to a user, in which case, the encryption ie according to the unique public/secret key of the relevant Z80 processor.

In an alternative embodiment the encrypted selected self-contained instruction set may be re-inserted in the software with appropriate header and footer information.

Where reference is made to registers being called or updated, this includes flags where appropriate.

Software modified as described above can be provided on a data carrier such as a CD ROM.

As an alternative to a separate processor, a secured part of the same (CPU) processor could be used, or by putting the same processor on to a secure mode.

Further code sections may be removed and supplied in encrypted form by the trusted source for decryption in the separate processor 30 for additional security. When decrypted, the removed code is re-inserted into the software 2.

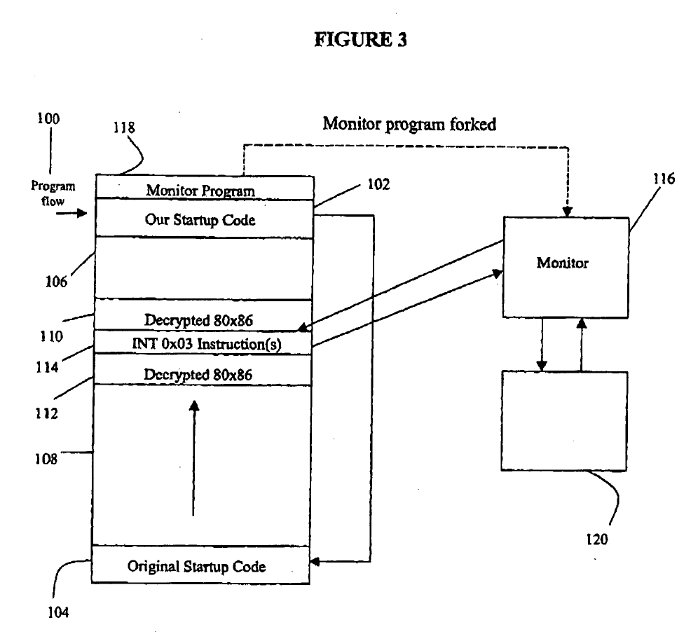

FIG. 3 shows a code module format incorporating the above embodiment of the present invention and the improvement in the preceding paragraph.

In FIG. 3, the program flow starts from 100 into the dedicated wrapper software 102 (also at 104). The bulk of the executable code of the software is at 106 and 108, within which there will be decrypted 80×86 code 110, 112 (see below) and INTO ×03 instructions 114.

Upon execution the wrapper software 102 launches a monitor application 116 stored within it at 118 from which the software commences execution as normal. The monitor application 116 is passed the process ID of the main application (the software) and the address of the chunk database. From this, the monitor application 116 can read/write/debug/control the original application.

First the monitor application fetches encrypted 80x86 code from a registry (preferably a remote registry) using the unique decryption of separate secure processor 120. The decrypted 80×86 code is placed into the RAM of the main application. If that data is not in the registry or does not decrypt correctly a diagnostic message is generated.

Once the 80×86 lock has been placed in the RAM of the application, encrypted code dedicated for the secure processor 120 is sought from the registry and placed into RAM of the monitor application. The code, at this point is not decrypted.

The monitor application permits the original application to execute waiting for a potential exception to occur (via a INT 0×03 instruction). When an exception occurs, it must be a BreakPoint, else the monitor will generate an error and terminate—thus terminating the original application also. When the monitor receives a BreakPoint, it scans it's database checking to see if it is a BreakPoint it knows about (if not, then it gives an error and terminates). Once the monitor knows which BreakPoint occurred it can ascertain the correct code for the secure processor 120 to execute.

On a Breakpoint the monitor application passes the encrypted code to the secure processor 120 complete with existing 80×86 registers and flags. The secure processor 120 will decrypt the encrypted code internally and execute it (if it fails to decrypt, then issue a diagnostic and exit).

Once the secure processor 120 has executed the encrypted code, the updated 80×86 registers and flags are placed back into the true 80×86 registers and execution returns to the application.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A method of modifying software comprising the steps of:
(i) selecting a self-contained instruction set from the software; and
(ii) modifying the software whereby when executed the selected self-contained instruction set is executed in a separate processor.

2. A method of modifying software according to claim , in which the separate processor is separate from the processor executing the non-selected, self-contained instruction set.

3. A method of modifying software according to claim 1 or claim 2, in which the selected self-contained instruction set is removed from the software.

4. A method of modifying software according to claim 3, in which the removed selected self-contained instruction set is replaced by an instruction to perform a corresponding instruction set on the separate processor.

5. A method of modifying software according to claim 3 or claim 4, in which the instruction-set comprises an instruction to enter a debugger mode.

6. A method of modifying software according to any one of claims 3 to 5, in which the removed self-contained instruction set is replaced by a corresponding length of substitute code.

7. A method of modifying software according to any preceding claim, in which the method includes the step of encrypting the selected self-contained instruction set.

8. A method of modifying software according to claim 7, in which the encryption is for a specific processor.

9. A method of modifying software according too claim 7 or claim 8, in which the encryption uses a public key encryption process.

10. A method of modifying software according to any one of claims 7 to 9, in which the selected self-contained instruction set is encrypted using a substantially unique encryption algorithm.

11. A method of modifying software according to claim 10, in which the substantially unique encryption algorithm corresponds to the substantially unique encryption algorithm of a processor adapted to decrypt and execute the encrypted self-contained instruction set.

12. A method of modifying software according to claim 11, in which the algorithm comprises a secret key algorithm.

13. A method of modifying software according to any one of claims 7 to 12, in which the encrypted selected self-contained instruction set is re-inserted into the software.

14. A method of modifying software according to any preceding claim, in which the processor is independent of a processor executing the non-encrypted software.

15. A method of modifying software according to any preceding claim, in which modification of the software includes providing wrapper software with the software.

16. A method of modifying software according to any preceding claim, in which an instruction set is only selected if it is of a predetermined minimum length.

17. A method of modifying software according to any preceding claim, in which the software is modified to provide the separate processor with at least one register entry for executing the selected self-contained instruction set.

18. A method of modifying software according to any preceding claim, in which the software is modified whereby the selected self-contained instruction set is retrieved from a location other than the source of the software.

19. A method of modifying software according to any preceding claim, in which the method includes the step of selecting and modifying plurality of self-contained instruction sets.

20. A method of executing software on a computer, the method comprising the steps of:
(i) upon reading an appropriate instruction, executing a self-contained instruction set in a separate processor; and
(ii) providing the result of the executed self-contained instruction set to the software.

21. A method of executing software on a computer according to claim 20, in which the software is according to the first aspect of the invention.

22. A method of executing software on a computer according to claim 20 or claim 21, in which a self-contained instruction set is provided separate from the software.

23. A method of executing software on a computer according to any one of claims 20 to 22, in which the appropriate instruction is an instruction to carry out an instruction set on a processor separate from a main processor.

24. A method of executing software on a computer according to claim 23, in which the appropriate instruction provides at least one register entry to the separate processor.

25. A method of executing software on a computer according to claim 24, in which an updated register entry is provided with the result of the executed self-contained instruction set.

26. A method of executing software on a computer according to any one of claims 20 to 25, in which the self-contained instruction set is executed on a secure processor, secure part of a processor or on a processor in a secure mode.

27. A method of executing software on a computer according to any one of claims 20 to 26, in which the self-contained instruction set is encrypted.

28. A method of executing software on a computer according to claim 27, in which the selected self-contained instruction set is encrypted using a substantially unique encryption algorithm.

29. A method of executing software on a computer according to claim 28, in which the substantially unique encryption algorithm corresponds to the substantially unique encryption algorithm of a processor adapted to decrypt and execute the encrypted self-contained instruction set.

30. A method of executing software on a computer according to claim 29, in which the algorithm comprises a secret key algorithm.

31. A method of executing software on a computer according to any one of claims 20 to 30, in which the self-contained instruction set is stored on memory of the separate processor.

32. A method of executing software on a computer according to claim 31, in which the self-contained instruction set is encrypted and is decrypted by the separate processor.

33. A method of executing software on a computer according to any one of claims 20 to 32, in which the method comprises the step of inserting in the software at the location of the self-contained instruction set a command to execute the encrypted self-contained instruction set.

34. A method of executing software on a computer according to claim 33, in which the command comprises an instruction to enter a debugger mode.

35. A data carrier comprising software modified according to any one of claims 1 to 19.

36. Software modified according to any one of claims 1 to 19.

37. A software execution process, the process comprising:
(i) providing software from which a self-contained instruction set has been modified to enable execution of the selected self-contained instruction set on a separate processor; and
(ii) executing the software during which the self-contained instruction set is executed on a separate processor.

38. A software execution process according to claim 37, in which a self-contained instruction set is obtained from a separate source and installed on the computer.

39. A software execution process according to claim 27 or claim 38, in which the self-contained instruction set is encrypted.

40. A software execution process according to claim 39, is in which the encryption is for a specific processor.

41. A software execution process according to claim 39 or claim 40, in which the selected self-contained instruction set is encrypted using a substantially unique encryption algorithm.

42. A software execution process according to claim 41, in which the substantially unique encryption algorithm corresponds to the substantially unique encryption algorithm of a processor adapted to decrypt and execute the encrypted self-contained instruction set.

43. A software execution process according to claim 41 or claim 42, in which the algorithm comprises a secret key algorithm.

44. A software execution process according to any one of claims 39 to 43, in which the processor is independent of a processor executing the non-encrypted software.

45. A software execution process according to any one of claims 39 to 44, in which the process includes the step of a separate process for decrypting the encrypted self-contained instruction set.

46. A software execution process according to any one of claims 39 to 45, in which the self-contained instruction set is stored on the separate processor.

47. A software execution process according to any one of claims 37 to 46, in which the method comprises the step of inserting in the software at the location of the self-contained instruction set a command to execute the encrypted self-contained instruction set.

48. A software execution process according to claim 47, in which the command comprises an instruction to enter a debugger mode.

49. A software execution process according to any one of claims 37 to 48, in which the encrypted self-contained instruction set is executed on a secure processor, a secure part of a processor or on a processor in a secure mode.

50. The software is according to claim 36.
